(19) United States
(12) Patent Application Publication
(10) Pub. No.: US 2015/0149541 A1
(43) Pub. Date: May 28, 2015

(54) Leveraging Social Media to Assist in Troubleshooting

(71) Applicant: International Business Machines Corporation, Armonk, NY (US)

(72) Inventors: Rose Catherine Kanjirathinkal, Kerala (IN); Sriram Raghavan, Bangalore (IN); Anindya Neogi, Bangalore (IN); Sai Dattathrani, Bangalore (IN)

(73) Assignee: International Business Machines Corporation, Armonk, NY (US)

(21) Appl. No.: 14/090,471

(22) Filed: Nov. 26, 2013

(51) Int. Cl. H04L 29/08

(52) U.S. Cl. CPC H04L 67/104
USPC 709/204

(57) ABSTRACT

Methods, systems, and articles of manufacture for leveraging social media to assist in troubleshooting are provided herein. A method includes extracting user-generated information pertaining to multiple failure scenarios from at least one social media data source; determining one or more causality relationships between a set of log entries associated with the multiple failure scenarios and the extracted user-generated information; identifying a similarity between the one or more determined causality relationships and information contained within a user query; and providing guidance to the user regarding resolving and/or obviating a failure associated with the user query based on said identified similarity.

### FIELD OF THE INVENTION

Embodiments of the invention generally relate to information technology (IT), and, more particularly, to IT troubleshooting techniques.

### BACKGROUND

Data analytics can include searching and analyzing structured and unstructured machine data to facilitate infrastructure and application management. Existing management approaches can include tools and capabilities to aid in problem isolation, root cause analysis, problem resolution, and preventive maintenance. By way of example, capabilities in the area of machine data analytics can include providing expert advice and generating alerts. Providing expert advice includes providing contextually relevant guidance and/or suggestions extracted from materials such as technical notes, articles, product documentation, etc. Generating alerts can include identifying system patterns (combinations of logs, metrics, configuration options, etc.) that are predictive of potential issues (for example, outages or service level agreement (SLA) violations) and raising alerts to the administrator and/or operator for preventive action.

Such existing management approaches, however, do not incorporate social media data derived from online discussion forums, message boards, social networks, etc. Social media data sources are growing sources of information, and current as well as prospective customers refer to such data for information on products and services.

Accordingly, a need exists for techniques capable of leveraging social media as a data source to provide contextually relevant guidance and alerts for IT troubleshooting.

### SUMMARY

In one aspect of the present invention, techniques for leveraging social media to assist in troubleshooting are provided. An exemplary computer-implemented method can include steps of extracting user-generated information pertaining to multiple failure scenarios from at least one social media data source; determining one or more causality relationships between a set of log entries associated with the multiple failure scenarios and the extracted user-generated information; identifying a similarity between the one or more determined causality relationships and information contained within a user query;

and providing guidance to the user regarding resolving and/or obviating a failure associated with the user query based on said identified similarity.

In another aspect of the invention, an exemplary computer-implemented method can include steps of extracting user-generated information pertaining to multiple failure scenarios from at least one social media data source; determining one or more causality relationships between a set of log entries associated with the multiple failure scenarios and the extracted user-generated information; computing a confidence value associated with each of the one or more determined causality relationships; identifying a similarity between the one or more determined causality relationships and information contained within a user query; and providing guidance to the user regarding resolving and/or obviating a failure associated with the user query based on said identified similarity and said computed confidence value associated with each of the one or more determined causality relationships.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example embodiment of the present invention;

FIG. 2 is a flow diagram illustrating techniques according to an embodiment of the invention; and

FIG. 3 is a system diagram of an exemplary computer system on which at least one embodiment of the invention can be implemented.

### DETAILED DESCRIPTION

As described herein, an aspect of the present invention includes leveraging social media to assist in troubleshooting IT infrastructure. At least one embodiment of the invention includes automatically learning pertinent failure scenarios from social media data and utilizing such information to analyze failures and/or potential failures.

As detailed herein, failure scenarios and/or failure patterns are not always known at the time of shipping a new product (or new versions of mature products). Also, content related to failure scenarios often appears in social media discussions earlier than such content appears as a formal bug report or “known issue” in product documentation.

Accordingly, at least one embodiment of the invention includes searching discussion sites and/or proprietary data for relevant failure scenarios and extracting pertinent information therefrom. For example, such pertinent information can include new log failure patterns, resolution details for a failure, severity of a failure, and lead time to failure. Additionally, at least one embodiment of the invention includes identifying the settings and/or configuration of a relevant system (if available) for accurate matching, as well as estimating the confidence of causality of the log pattern to the failure. Further, a prioritization method based on the above for each log pattern—failure pair can be determined.

Consequently, at least one embodiment of the invention includes using learned knowledge such as detailed above to identify and/or predict impending failures from logs, prioritizing impending failures, as well as providing resolution advice.

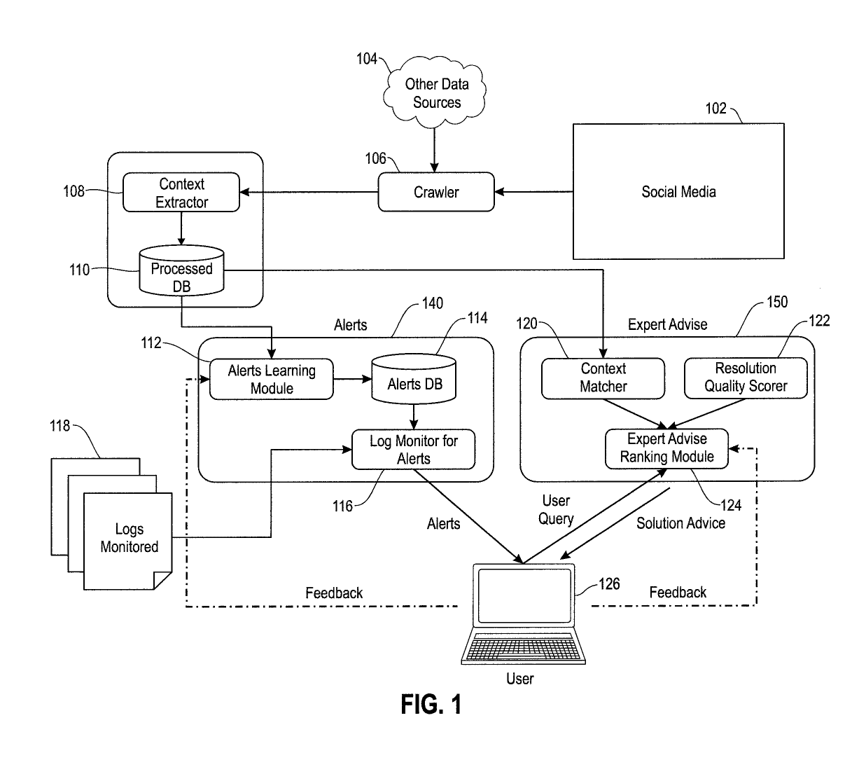

FIG. 1 is a diagram illustrating an example embodiment of the present invention. By way of illustration, FIG. 1 depicts social media data sources 102, other data sources 104 and a crawler component 106, which interacts with a content extractor component 108. As further described herein, the context extractor component 108 provides input to a processed database (DB) 110, which correspondingly provides input to an alerts module 140 as well as an expert advice module 150.

In at least one embodiment of the invention, the crawler component 106 is an automated bot that systematically downloads the pertinent set of web pages from social media websites and other data sources of interest. The crawler component 106 makes these pages available locally for other components to analyze the content text so as to extract relevant information. Also, the crawler component 106 may carry out a one-time download of pages, or may track new pages added to the website(s) and edits made to previously downloaded pages. The crawler component 106 may then download the new and/or changed pages and incrementally update a local copy.

The context extractor component 108 extracts context and details of failure scenarios from social media data sources 102 as well as other data sources 104. Additionally, the alerts module 140 automatically learns new alerts based on input provided by the context extractor component 108, and the expert advice module 150 generates and/or provides contextually relevant advice for resolving and/or obviating impeding failures.

As illustrated in FIG. 1, the context extractor component 108 searches discussion sites and/or proprietary data for relevant failure scenarios, and extracts information pertaining to failures described in social media discussion as well as log entries associated with the failures. The context extractor component additionally identifies information such as the settings and/or configuration of relevant systems, whenever available, resolution details for the failure, severity of the failure, lead time to failure, etc., and assigns a confidence estimate for each extraction.

Accordingly, for each discussion thread Dᵢ, the context extractor component 108 can:

Extract a problem P_{Di} using the method M_{extractProblem}(Dᵢ);

Extract log messages L_{Di} using the method M_{extractLogMessage}(Dᵢ);

Extract a resolution R_{Di} using the method M_{extractResolution}(Dᵢ);

Extract a severity measure S_{Di} using the method M_{extractSeverity}(Dᵢ);

Extract lead time to failure T_{Di} using the method M_{extractLeadTime}(Dᵢ); and

Extract the settings and/or configuration of a system in Dᵢ, C_{Di} using the method M_{extractConfiguration}(Dᵢ).

The above extractions can be carried out, by way merely of example, via techniques such as Cong et al., “Finding question-answer pairs from online forums,” Proceedings of the 31st annual international ACM SIGIR conference on Research and development in information retrieval, Pages 467-474, July 2008; Chiticariu et al., “SystemT: An Algebraic Approach to Declarative Information Extraction,” Proceedings of the ACL-HLT 2011 System Demonstrations, pages 109-114, June 2011; Ding et al., “Using conditional random fields to extract contexts and answers of questions from online forums,” Proceedings of ACL-08: HLT, pages 710-718, June 2008; Hong et al., “A classification-based approach to question answering in discussion boards,” Proceedings of the 32nd international ACM SIGIR conference on Research and development in information retrieval, Pages 171-178, July 2009; Gangadharaiah et al., “PriSM: discovering and prioritizing severe technical issues from product discussion forums,” Proceedings of the 21st ACM international conference on Information and knowledge management, Pages 1627-1631, October 2012; Zheng et al., “A practical failure prediction with location and lead time for Blue Gene/P,” Proc. International Conference on Dependable Systems and Networks Workshops (DSN-W), Pages 15-22, Jun. 28, 2010-Jul. 1, 2010; Probst et al., “Semi-Supervised Learning to Extract Attribute-Value Pairs from Product Descriptions on the Web,” IJCAI'07 Proceedings of the 20th international joint conference on Artificial intelligence, Pages 2838-2843, 2007; Agrawal et al., “Mining association rules between sets of items in large databases,” SIGMOD '93 Proceedings of the 1993 ACM SIGMOD international conference on Management of data, Pages 207-216, 1993; Pei et al.,” Prefix Span: Mining sequential patterns efficiently by prefix-projected pattern growth,” ICDE '01 Proceedings of the 17th International Conference on Data Engineering, Page 215, April 2001; T. Joachims, “Optimizing Search Engines Using Clickthrough Data,” KDD '02 Proceedings of the eighth ACM SIGKDD international conference on Knowledge discovery and data mining, Pages 133-142, July 2002; and Majumdar et al., “Privacy protected knowledge management in services with emphasis on quality data,” CIKM '11 Proceedings of the 20th ACM international conference on Information and knowledge management, Pages 1889-1894, October 2011, the disclosures of which are incorporated by reference herein in their entirety. One or more embodiments of the invention can additionally include the use of standard text clustering techniques, weighted average techniques, topological techniques, and text similarity techniques.

For each of the above-noted extractions, the context extractor component 108 can also save a confidence of the extraction Conf(.) as output by the methods above.

The method used to compute the confidence value can vary according to the machine learning technique that is used to extract the value. In an example embodiment of the invention that includes estimating M_{extractSeverity}(Dᵢ), the method may include using the presence of certain terms and/or phrases such as “product is unusable,” “system crashes,” “terrible experience,” etc. mentioned in the online discussion, as well as the number of times such phrases repeat, so as to categorize the problem being described in that discussion as ‘High Severity.’ Absence of such words and/or phrases may be indicative, in such an example, of a ‘Low Severity’ problem. Further, such an implementation may identify the level of expertise of the person reporting the problem to assess the severity of the issue. For example, if an expert complains about a certain problem, it is likely that the problem is severe, as compared to a novice user who may be complaining because s/he is not yet conversant with the product.

The alerts module 140 includes an alerts learning module 112, which receives input from the processed database 110 and learns causality relationships between log entries and a given failure, including an estimate of a confidence value associated with the causality. The alerts learning module 112 additionally learns a prioritization method for each log entry—failure pair, and uses the above learned knowledge to identify and/or predict impending failures from logs, prioritize the impending failures using the learned method, and alerts an administrator (or user or analogous authority) about the impeding failures whose predicted probability of actually occurring is higher than a given threshold. Accordingly, as also illustrated in FIG. 1, the alerts learning module 112 provides input to an alerts database 114, which provides input to a log monitoring component 116. The log monitoring component 116 receives additional input from monitored logs 118, and provides alerts to a user 126, as detailed above. The user 126 can subsequently provide feedback to the alerts learning module 112.

As detailed herein, there are two sources of logs. For instance, one source includes those logs that are available from the social media which people may have posted while reporting an issue. This source, as described herein, is crawled and analyzed. Such logs were generated on a social media user's machine, and such logs may be limited because people may not post the entire log—they may post only snippets. A second source includes the actual logs of the system being monitored; that is, the system on which an embodiment of the invention is deployed, and for which it is sought to provide the alerts using intelligence derived from the logs of the first source. Accordingly, the second source of logs will have logs that are generated because of user activity or activity on that machine such as disk full, network unreachable, etc. As illustrated in FIG. 1, module 112 and database 114 work on the first source of logs, while logs 118 are derived from the second source. Module 116 uses the information learned from the logs derived from the first source by module 112 and stored in database 114 to raise warnings on the second source of logs via module 118.

At least one embodiment of the invention includes, for each discussion thread Dᵢ, computing causality rules of the form L_{Di}→P_{Di}, using method M_{causality}(L_{Di}, P_{Di}). Additionally, such an embodiment includes estimating a confidence value associated with the causality rules, wherein a local estimate at the discussion level can be indicated by Dᵢ, Conf_{Di}(L_{Di}→P_{Di}) using method M_{estimateConfidence}(Dᵢ). Further, in at least one embodiment of the invention, all rules with a confidence value below a threshold are discarded. A confidence score can include features representing indicators from the discussion thread, such as data source authenticity and popularity, an expert level of the problem poster, the authority and/or expert level of the problem solver, the number of votes for the discussion and/or the answer post, the number of verbal confirmations within the discussion thread, the discussion being marked as resolved, etc.

Also, at least one embodiment of the invention includes clustering the causality rules using M_{cluster} across given data sources and discussions to obtain a set of unique rules: π={(L₁→P₁), (L₂→P₂), . . . }. Note that different Lᵢs can cause the same Pⱼ and the same Lᵢ can cause multiple Pⱼs. The clustering stage includes de-duplicating the different descriptions of the same problem to obtain a unique set of problems. Because the set of problems is obtained from, for example, online discussions, and because such inputs are in natural language free text, the same issue may be described in multiple ways. For instance, one discussion may revolve around solving some ‘billing error,’ while another discussion may refer to the same problem as an ‘invoice issue,’ leading to two rules. However, after clustering, if it is determined that “Billing Error” and “Invoice Issue” are in fact the same issue and clustered into the same cluster, then, only one of the rules need to be retained. In at least one embodiment of the invention, any standard document clustering algorithm can be utilized, and one or more embodiments of the invention may also include the use of a dictionary of synonyms to estimate the similarity of different terms in the input documents.

For each causality rule (Lⱼ→Pⱼ) in π, at least one embodiment of the invention includes computing global measures and/or scores using aggregating functions as follows:

Average severity S_{global}(Lⱼ→Pⱼ)=A_{severity}(S_{Di}) for all Dᵢ that produced the rule (Lⱼ→Pⱼ);

Average and/or expected lead time to failure T_{global}(Lⱼ→Pⱼ)=A_{leadTime}(T_{Di}) for all Dᵢ that produced the rule (Lⱼ→Pᵢ); and

Global estimate of the confidence of the causality rule Conf_{global}(Lⱼ→Pⱼ)=A_{confidence}(Conf_{Di}) for all Dᵢ that produced the rule (Lⱼ→Pⱼ).

As noted above, the alerts learning module can prioritize warnings for impending failures. As such, at a time instance t, φₜ is considered the set of causality rules that hold; that is, the rules whose cause has been observed in the log files being monitored. This set can be computed as φₜ={(L₁→P₁), (L₂→P₂), . . . }. Additionally, at least one embodiment of the invention includes computing a value pertaining to the importance or criticalness at time t of each (Lⱼ→Pⱼ) in φₜ as: Score_{critical}(Lⱼ43 Pⱼ)=M_{critical}(S_{global}(Lⱼ→Pⱼ), T_{global}(Lⱼ→Pⱼ), Conf_{global}(Lⱼ→Pⱼ), and Sim_{configuration}(C_{Di}, Cₐₚₚ)), where Sim_{configuration}(C_{Di}, Cₐₚₚ) provides the similarity between the configuration of the application being monitored, Cₐₚₚ, and the configurations under which the causality has been observed before, C_{Di}. M_{critical} is a method which generates a combined and/or overall score based on the individual scores for each of the four dimensions (that is, S_{global}, T_{global}, Conf_{global} and Sim_{Configuration}), and the method generates a higher score for more critical rules.

At time instance t, at least one embodiment of the invention includes sorting all causality rules in φₜ in descending order of Score_{critical} value to power a warning system of impending failures. The system (via component 116, as illustrated in FIG. 1) can proactively alert an administrator when Score_{critical}>threshold_{critical}. Further, as also noted above, a feedback loop can be established between the user 126 (administrator) and the alerts learning module 112 to feed manual feedback and/or corrections on the reported priority of failures to modify M_{critical}.

As also illustrated in FIG. 1, the expert advice module 150 includes a context matcher component 120 (which receives input from the processed database 110) and a resolution quality scorer component 122, which both provide input to an expert advice ranking module 124. As detailed herein, the expert advice ranking module 124 receives a user query from user 126 and correspondingly provides solution advice to the user 126 based on the information described herein.

By way of example, for a given failure scenario, the context matcher component 120 attempts to match the context of the failure to failures extracted from social media and provided to the expert advice module 150 from the processed database 110. Additionally, the expert advice ranking module 124 utilizes a ranking algorithm which incorporates factors such as reliability of the social media source, the level of matching between the problem described in the input failure (query) and the extracted failure, the context match score between the input failure and the failure described in the online discussion, and a confidence value and/or quality of the resolution (computed via component 122) extracted from the online discussion to suggest possible resolutions for the input failure. Ranking can include, by way of example, sorting on the M_{relevance} scores. Additionally, to obtain the M_{relevance} score, at least one embodiment of the invention includes training a ranking support vector machine (RankSVM) statistical model. Additionally, the user 126 can provide feedback to the expert advice ranking module 124 to refine the ranking algorithm.

For an input (Pₐₚₚ, Cₐₚₚ), the problem and the configuration of the application being monitored, at least one embodiment of the invention includes computing a relevance score for each of the resolutions available from the context extractor component 108 as: Score_{relevance}(R_{Di})=M_{relevance}(Reliability_{Source}(R_{Di}) Sim_{problem}(P_{Di}) Pₐₚₚ), Sim_{configuration}(C_{Di}, Cₐₚₚ), Quality(R_{Di})), wherein:

Reliability_{Source}(R_{Di}) provides the reliability of the source;

Sim_{problem}(P_{Di}, Pₐₚₚ) provides the similarity of the input problem and the problem addressed by the online discussion thread;

Sim_{configuration}(C_{Di}, Cₐₚₚ) is the same as defined above in connection with the alerts module 140; and

Quality(R_{Di}) provides the quality of the resolution. This score is lowest for posts in the discussion that are not solution suggestions. This resolution score can also prioritize a well-detailed solution over a terse single sentence answer.

Additionally, M_{relevance} is a method which provides a combined and/or overall score based on the individual scores for each of the four dimensions, and provides a higher score for more relevant elements. At least one embodiment of the invention also includes sorting and/or ranking the R_{Di}s in decreasing order of Score_{relevance}(R_{Di}) to suggest one or more resolutions for the input problem. Further, as noted above, a feedback loop can be established between the user 126 (administrator) and the expert advice ranking module 124 to feed manual feedback and/or correction on the reported order of relevance of the resolutions to modify M_{relevance.}

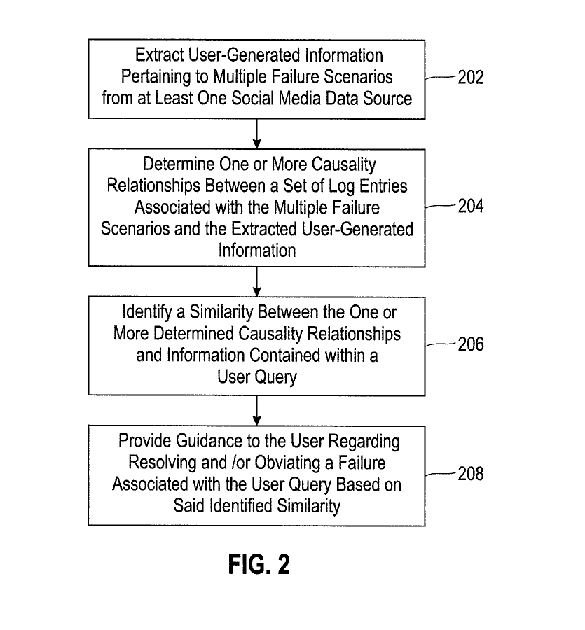

FIG. 2 is a flow diagram illustrating techniques according to an embodiment of the present invention. Step 202 includes extracting user-generated information pertaining to multiple failure scenarios from at least one social media data source. Such an extracting step can include searching at least one social media data source for one or more failure scenarios. Additionally, a social media data source can include an online discussion forum, an online message board, and/or a social network page, and user generated information can include a user description of a failure.

In at least one embodiment of the invention, the extracting step can additionally include identifying one or more settings and/or configuration of a system associated with one or more of the multiple failure scenarios, determining resolution details as well as a lead time associated with one or more of the multiple failure scenarios, and determining a severity level of one or more of the multiple failure scenarios.

Step 204 includes determining one or more causality relationships between a set of log entries associated with the multiple failure scenarios and the extracted user-generated information. At least one embodiment of the invention additionally includes prioritizing the one or more determined causality relationships.

Step 206 includes identifying a similarity between the one or more determined causality relationships and information contained within a user query. At least one embodiment of the invention can additionally include enabling receipt of feedback from the user to modify this identification step. Step 208 includes providing guidance to the user regarding resolving and/or obviating a failure associated with the user query based on said identified similarity.

The techniques depicted in FIG. 2 can also include computing a probability of occurrence of a failure associated with the user query based on said identified similarity. Accordingly, providing guidance can also include alerting the user about the failure associated with the user query if the computed probability of occurrence exceeds a given threshold amount.

Further, the techniques depicted in FIG. 2 can include ranking said one or more determined causality relationships. Such ranking can include ranking said one or more determined causality relationships based on reliability of the at least one social media data source, and/or ranking said one or more determined causality relationships based on the degree of similarity between the one or more determined causality relationships and the information contained within the user query. Also, at least one embodiment of the invention includes enabling receipt of feedback from the user to modify the ranking step.

As described herein, at least one embodiment of the invention can also include computing a confidence value associated with each of the one or more determined causality relationships. Such an embodiment can additionally include providing guidance to the user regarding resolving and/or obviating a failure associated with the user query based on said identified similarity and said computed confidence value associated with each of the one or more determined causality relationships. Computing a confidence value can be based on authenticity of the at least one social media data source, popularity of the at least one social media data source, and/or an amount of additional user-generated information related to the extracted user-generated information.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

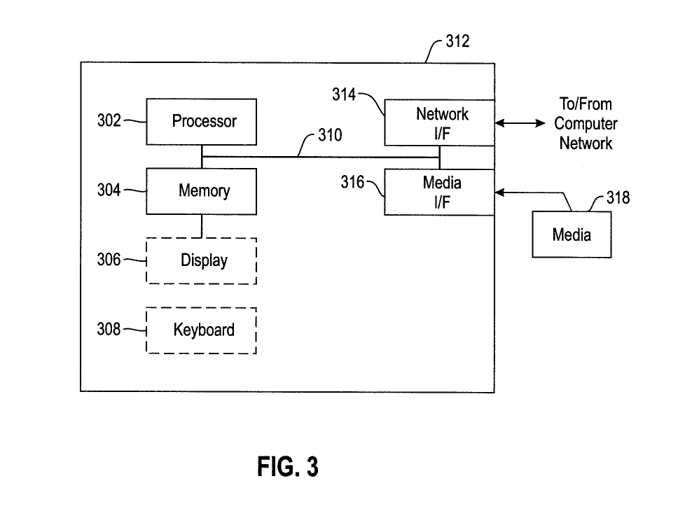

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation. Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, leveraging social media to automatically learn alerts from pertinent failure scenarios and use such alerts to identify and/or predict and prioritize failures for troubleshooting IT infrastructure.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
extracting user-generated information pertaining to multiple failure scenarios from at least one social media data source;
determining one or more causality relationships between a set of log entries associated with the multiple failure scenarios and the extracted user-generated information;
identifying a similarity between the one or more determined causality relationships and information contained within a user query; and
providing guidance to the user regarding resolving and/or obviating one or more failures associated with the user query based on said identified similarity, wherein said guidance comprises multiple alerts associated with multiple failures, and wherein said providing comprises:
prioritizing said multiple alerts based on (i) a computed severity of each of the multiple failures, (ii) an expected lead time to failure associated with each of the multiple failures, and (iii) a computed confidence value associated with each of the one or more determined causality relationships;
wherein at least one of said extracting, said determining, said identifying and said providing is carried out by a computing device.

2. The method of claim 1, wherein said extracting comprises searching the at least one social media data source for one or more failure scenarios.

3. The method of claim 1, wherein said at least one social media data source comprises an online discussion forum, an online message board, and/or a social network page.

4. The method of claim 1, wherein said user-generated information comprises a user description of a failure.

5. The method of claim 1, wherein said extracting further comprises identifying one or more settings and/or configuration of a system associated with one or more of the multiple failure scenarios.

6. The method of claim 1, wherein said extracting further comprises determining resolution details associated with one or more of the multiple failure scenarios.

7. The method of claim 1, wherein said extracting further comprises determining a severity level of one or more of the multiple failure scenarios.

8. The method of claim 1, wherein said extracting further comprises determining a lead time associated with one or more of the multiple failure scenarios.

9. The method of claim 1, comprising:
prioritizing the one or more determined causality relationships.

10. The method of claim 1, comprising:
computing a probability of occurrence of a failure associated with the user query based on said identified similarity.

11. The method of claim 10, wherein said providing guidance to the user comprises alerting the user about the failure associated with the user query if the computed probability of occurrence exceeds a given threshold amount.

12. The method of claim 1, comprising:
enabling receipt of feedback from the user to modify said identifying.

13. The method of claim 1, comprising:
ranking said one or more determined causality relationships.

14. The method of claim 13, wherein said ranking comprises ranking said one or more determined causality relationships based on reliability of the at least one social media data source.

15. The method of claim 13, wherein said ranking comprises ranking said one or more determined causality relationships based on the degree of similarity between the one or more determined causality relationships and the information contained within the user query.

16. The method of claim 13, comprising:
enabling receipt of feedback from the user to modify said ranking.

17. An article of manufacture comprising a non-transitory computer readable storage medium having computer readable instructions tangibly embodied thereon which, when implemented, cause a computer to carry out a plurality of method steps comprising:
extracting user-generated information pertaining to multiple failure scenarios from at least one social media data source;
determining one or more causality relationships between a set of log entries associated with the multiple failure scenarios and the extracted user-generated information;
identifying a similarity between the one or more determined causality relationships and information contained within a user query; and
providing guidance to the user regarding resolving and/or obviating one or more failures associated with the user query based on said identified similarity, wherein said guidance comprises multiple alerts associated with multiple failures, and wherein said providing comprises:
prioritizing said multiple alerts based on (i) a computed severity of each of the multiple failures, (ii) an expected lead time to failure associated with each of the multiple failures, and (iii) a computed confidence value associated with each of the one or more determined causality relationships.

18. A system comprising:
a memory; and
at least one processor coupled to the memory and configured for:
extracting user-generated information pertaining to multiple failure scenarios from at least one social media data source;
determining one or more causality relationships between a set of log entries associated with the multiple failure scenarios and the extracted user-generated information;
identifying a similarity between the one or more determined causality relationships and information contained within a user query; and
providing guidance to the user regarding resolving and/or obviating one or more failures associated with the user query based on said identified similarity, wherein said guidance comprises multiple alerts associated with multiple failures, and wherein said providing comprises:
prioritizing said multiple alerts based on (i) a computed severity of each of the multiple failures, (ii) an expected lead time to failure associated with each of the multiple failures, and (iii) a computed confidence value associated with each of the one or more determined causality relationships.

19. A method comprising:
extracting user-generated information pertaining to multiple failure scenarios from at least one social media data source;
determining one or more causality relationships between a set of log entries associated with the multiple failure scenarios and the extracted user-generated information;
computing a confidence value associated with each of the one or more determined causality relationships;
identifying a similarity between the one or more determined causality relationships and information contained within a user query; and
providing guidance to the user regarding resolving and/or obviating one or more failures associated with the user query based on said identified similarity and said computed confidence value associated with each of the one or more determined causality relationships, wherein said guidance comprises multiple alerts associated with multiple failures, and wherein said providing comprises:
prioritizing said multiple alerts based on (i) a computed severity of each of the multiple failures, (ii) an expected lead time to failure associated with each of the multiple failures, and (iii) said computed confidence value associated with each of the one or more determined causality relationships;
wherein at least one of said extracting, said determining, said computing, said identifying, and said providing is carried out by a computing device.

20. The method of claim 19, wherein said computing comprises computing the confidence value based on authenticity of the at least one social media data source, popularity of the at least one social media data source, and/or an amount of additional user-generated information related to the extracted user-generated information.
